(19) United States
(12) Patent Application Publication
(10) Pub. No.: US 2006/0092094 A1
(43) Pub. Date: May 4, 2006

(54) Media display device

(75) Inventors: Timothy Jude Kennedy, Staten Island, NY (US); Agnete Enga, Brooklyn, NY (US); Boris Kontorovich, Brooklyn, NY (US); Luis Arsenio Garcia Monsalve, Brooklyn, NY (US); Dominik Langhammer, Stuttgart (DE); Howard Wollner, Seattle, WA (US); Darren Medina, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Starbucks Corporation, Seattle, WA (US)

(21) Appl. No.: 11/215,215

(22) Filed: Aug. 30, 2005

Related U.S. Application Data
(60) Provisional application No. 60/619,570, filed on Oct. 14, 2004.

(51) Int. Cl. G09G 5/00

(52) U.S. Cl. 345/1.1

(57) ABSTRACT

A housing defines an interior volume adapted to removably receive a tablet personal computer. A view opening disposed in the housing permits a user to view a graphics screen of the tablet personal computer when the tablet personal computer is received by the interior volume. A print media holder assembly is coupled to the housing for removably holding print media for viewing by the user.

### CROSS REFERENCE TO RELATED APPLICATION

This application claims the benefit of Provisional Application No. 60/619,570, filed Oct. 14, 2004, the benefit of which is hereby claimed under 35 U.S.C. §119.

### FIELD OF THE INVENTION

The present invention relates to displaying images to a viewer.

### BACKGROUND OF THE INVENTION

Print media images, such as an advertisement, poster, photograph, and so on, are typically displayed to the viewer by mounting the print media directly on a supporting surface or encasing the print media in a frame. Other times, the print media can be mounted so as to be freestanding. In the case of electronic media images, general purpose or custom monitors or screens are used to display electronic images to a viewer.

### SUMMARY OF THE INVENTION

The illustrated embodiments of the present invention provide an improved media display device that may provide one or more of the following advantages-presenting media in multiple viewing planes; displaying multiple media types; presenting media in adjustable positions; providing a card reader or a card reader recess for receiving a card reader adjacent to the displayed media; and/or capable of receiving an off-the-shelf graphics display device.

In one embodiment of a media display device in accordance with the present invention, a housing at least partially defines an interior volume adapted to removably receive a tablet personal computer. The media display device further includes a view opening disposed in the housing for permitting a user to view a graphics screen of the tablet personal computer when the tablet personal computer is received by the interior volume. The media display device still further includes a print media holder assembly coupled to the housing for removably holding print media for viewing by the user.

The housing may include a first planar section and a second planar section inclined relative to the second planar section. For instance, the first planar section may be angled 10 degrees to 50 degrees relative to the second planar section. The first planar section may include the view opening and the second planar section may include the print media holder assembly. The media display device may include a plurality of vent openings. The housing may include a recess adapted to receive a card reader. The housing may include an elongate slot for permitting a card containing readable data to be swiped therethrough. The media display device may include an access aperture disposed in the housing for accessing a power button of a tablet personal computer when the tablet personal computer is disposed in the housing. The media display device may include a mounting assembly coupled to the housing, the mounting assembly being adapted to couple to a support surface for adjustably suspending the media display assembly a predetermined distance above the support surface. The mounting assembly may include a pivot assembly for permitting the housing to be selectively pivoted to permit an inclination of the housing to be adjusted relative to the support surface. The mounting assembly may include a swing assembly for permitting the housing to be selectively rotated about a swing axis to allow the housing to be reciprocated along a predetermined path above the support surface. The mounting assembly may further include a hanger extending outward from the mounting assembly for suspending a pair of headphones above the support surface.

In another alternate embodiment of a media display device in accordance with the present invention, the media display device includes a housing at least partially defining an interior volume adapted to removably receive a screen for viewing digital or other electronic images. The media display device also includes a media holder coupled to the housing for removably holding print media.

The housing may include a first planar section adapted to receive the screen and a second planar section coupled to the first planar section. The second planar section may include the print media holder and the first planar section may be inclined relative to the second planar section. The first planar section may be inclined relative to the second planar section between about 10 degrees to about 50 degrees. The housing may further include an elongate slot for permitting a card containing readable data to be swiped therethrough. The media display device may include an access aperture disposed in the housing. The access aperture may be selectively configurable between an access position permitting user access to the interior volume and a closed position impeding user access to the interior volume. The access aperture may be located in proximity to a power button associated with the screen when the screen is held by the media display device. The interior volume may be sized and configured to at least partially receive a tablet personal computer having the screen. The media display device may include a mounting assembly coupled to the housing. The mounting assembly may be coupled to a support surface for adjustably suspending the media display assembly a predetermined distance above the support surface. The mounting assembly may include a pivot assembly for permitting the housing to be selectively pivoted to permit an inclination of the housing to be adjusted relative to the support surface. The mounting assembly may include a swing assembly for permitting the housing to be selectively rotated about a swing axis to allow the housing to be reciprocated along a predetermined path above the support surface. The mounting assembly may further include a hanger extending outward from the mounting assembly for suspending a pair of headphones above the support surface.

In still another alternate embodiment of a media display device in accordance with the present invention, the media display device includes a housing having a first section angled relative to a second section. A first graphics device is coupled to the first section, the first graphics device including a tablet personal computer for displaying media images for user viewing. A second graphics device is coupled to the second section, the second graphics device being adapted to display print media images for user viewing.

The media display device may include a card reader coupled to the housing. The first section may be inclined greater than about 10 degrees from the second section. The second graphics device may include a holder for holding print media. The second graphics device may be a tablet personal computer. The media display device may include a mounting assembly coupled to the housing. The mounting assembly may be adapted to couple to a support surface for adjustably suspending the media display assembly a predetermined distance above the support surface. The mounting assembly may include a pivot assembly for permitting the housing to be selectively pivoted to permit an inclination of the housing to be adjusted relative to the support surface. The mounting assembly may include a swing assembly for permitting the housing to be selectively rotated about a swing axis to allow the housing to be reciprocated along a predetermined path above the support surface. The mounting assembly may further include a hanger extending outward from the mounting assembly for suspending a pair of headphones above the support surface.

### BRIEF DESCRIPTION OF THE DRAWINGS

The foregoing aspects and many of the attendant advantages of this invention will become better understood by reference to the following detailed description, when taken in conjunction with the accompanying drawings, wherein:

FIG. 1 is a top perspective of one embodiment of a pair of media display devices in accordance with the present invention, coupled to a desk;

FIG. 2 is a top perspective of one of the media display devices of FIG. 1 depicting a front side of the media display device;

FIG. 3 is a rear perspective of the media display device of FIG. 2 depicting a back side of the media display device;

FIG. 3A is a section taken along line 3A-3A of FIG. 3;

FIG. 4 is a rear perspective of the media display device of FIG. 3 with parts shown in an exploded relationship;

FIG. 5 is a side elevation of an alternate embodiment of a media display device in accordance with the present invention;

FIG. 6 is a top plan of the media display device of FIG. 5;

FIG. 7 is a section taken along line 7-7 of FIG. 5; and

FIG. 8 is a rear perspective of an alternate embodiment of a media display device in accordance with the present invention, with parts shown in exploded relationship.

### DETAILED DESCRIPTION OF THE PREFERRED EMBODIMENT

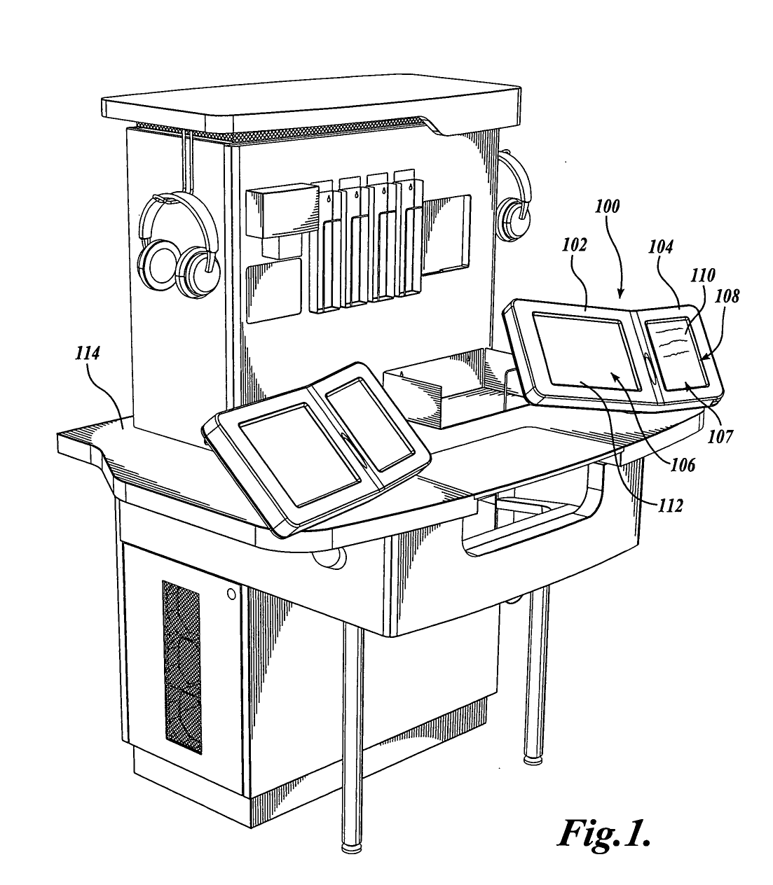

One embodiment of a media display device 100 in accordance with the present invention is shown in FIG. 1, illustrating two media display devices 100 mounted on a desk, kiosk, or other support structure 114. The media display device 100 includes a first panel 102 and a second panel 104 angled relative to one another to emulate the appearance of an open book. Associated with the first panel 102 is a first graphics device 106 adapted to display electronic images. Associated with the second panel 104 is a second graphics device 107 including a print media holder assembly 108 adapted to hold print media 110 having images thereon, a few suitable examples being advertisements and use instructions.

Preferably, the first graphics device 106 is a graphical user interface device such as a tablet personal computer that is adapted to both display electronic images upon a screen 112 and receive information from a user. The media display device 100 is adapted to be movably coupled to the support structure 114, a few suitable examples being a table, a chair, countertop, desk, etc. Preferably, the media display device 100 is adjustably suspended above the support structure 114 in such a manner that the angular position and/or inclination of the media display device 100 may be altered to a selected ergonomic position during use.

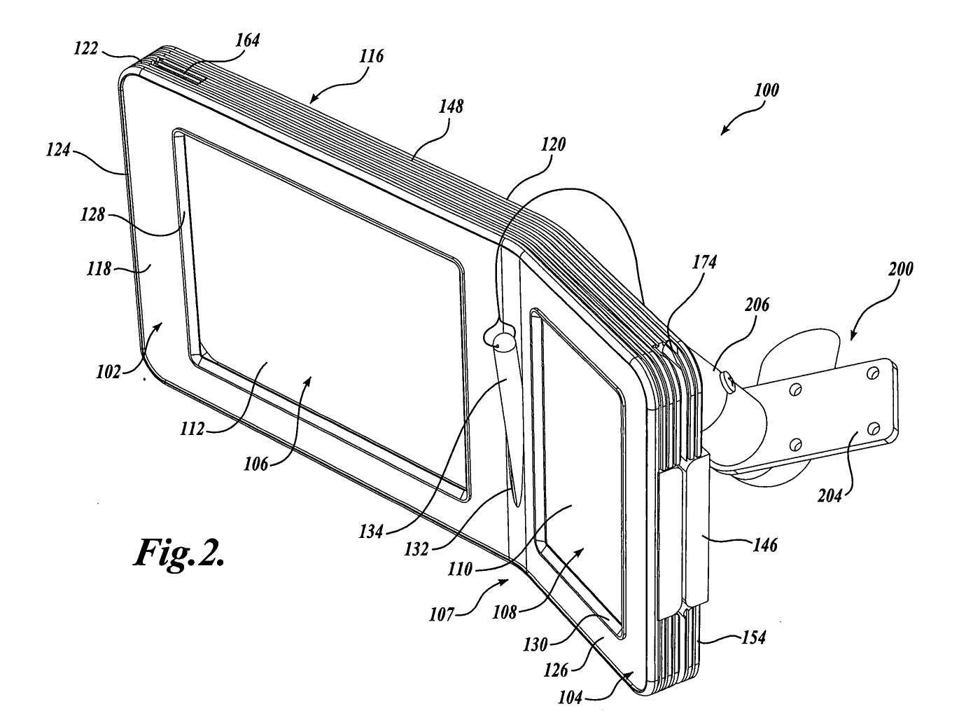

Referring to FIGS. 2-4, the media display device 100 includes a housing 116 having a front panel 118, a back panel 120, and a peripheral frame 122. The front panel 118 includes a first planar section 124 angled relative to a second planar section 126. The angle between the two sections is greater than 0 degrees and less than about 90 degrees, preferably in the range of between about 10 degrees and about 50 degrees, with a preferred angle of about 20 degrees.

The first planar section 124 has a digital media view opening 128 that permits a user to view a screen 112 of the graphics device 106. The graphics device 106 may be any device capable of displaying electronic media images, a few suitable examples being tablet personal computers, such as pen- or stylus-based personal computers, one suitable example being a HEWLETT-PACKARD COMPAQ Tablet Personal Computer, Model No. tc1100, and another suitable example being Personal Digital Assistants (PDAs). In one embodiment, the graphics device 106 is able to both display information to a user and receive information from a user from an input device, such as a mouse, keyboard, touch screen, etc.

The second planar section 126 has a print media view opening 130 that permits a user to view images of the second graphics device 107. The second graphics device 107 can be print media 110, e.g., a card or sheet containing, for example, instructions, advertising, graphics, or a combination thereof. The front panel 118 includes a stylus mount, such as an aperture 132 adapted to removably receive the top portion of a stylus 134 when not in use.

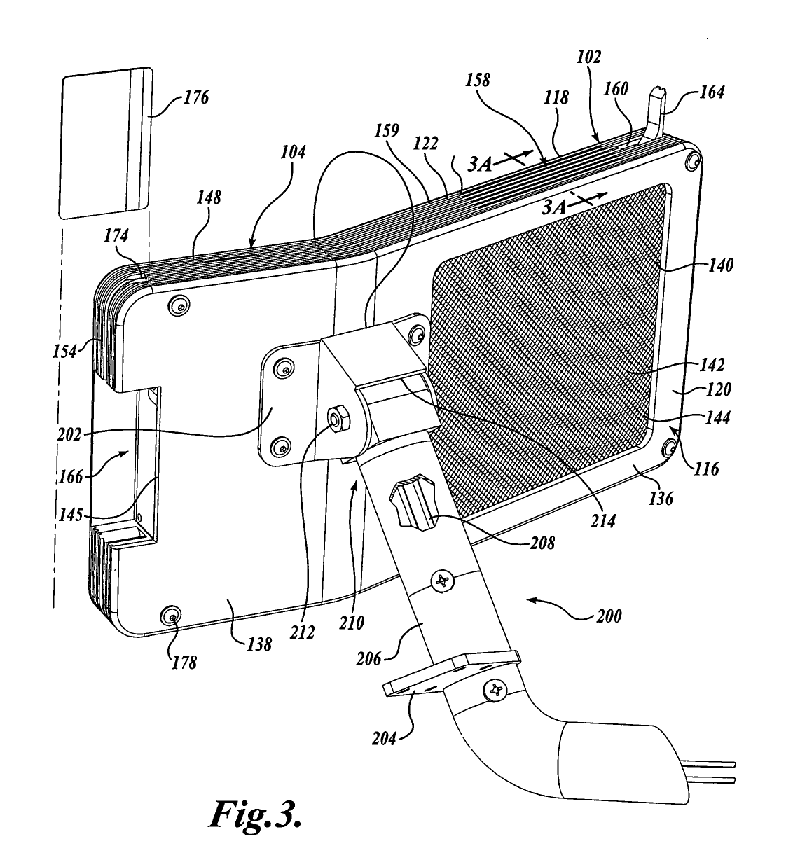

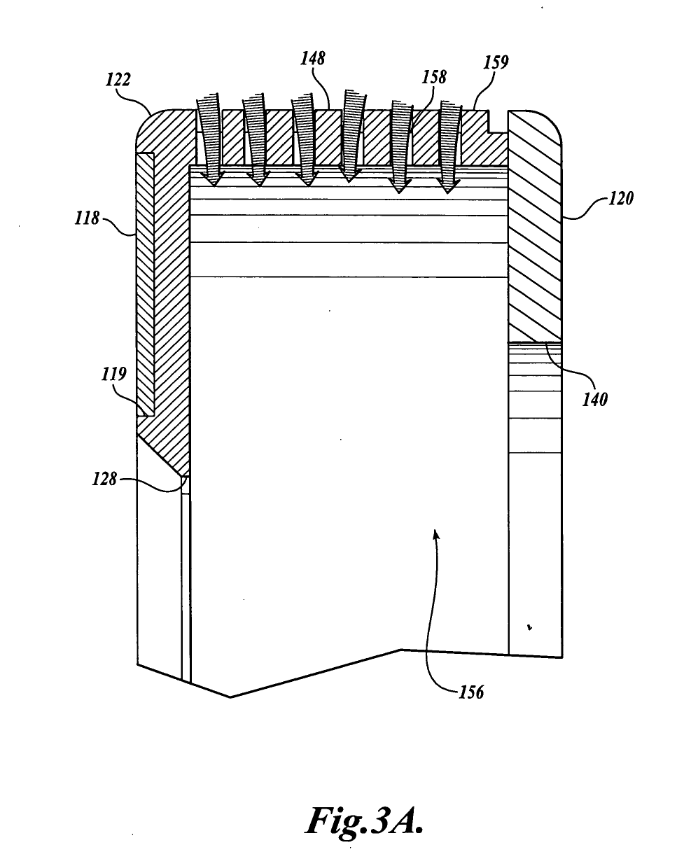

With reference to FIG. 3, the back panel 120 includes a first planar section 136 angled relative to a second planar section 138. The first planar section 136 is inclined from the second planar section 138 greater than 0 degrees and less than about 90 degrees, preferably inclined in the range of between about 10 degrees and about 50 degrees, with a preferred angle of inclination of about 20 degrees. The first planar section 136 has a vent opening 140. Disposed behind the vent opening 140 is a vent panel 142 having a plurality of apertures 144 for permitting airflow into and/or out of the media display device 100. The back panel 120 may further include a card reader cutout 145 for receiving a card reader 146 (FIG. 2, removed in FIG. 3 for clarity) to be connected to the media display device 100.

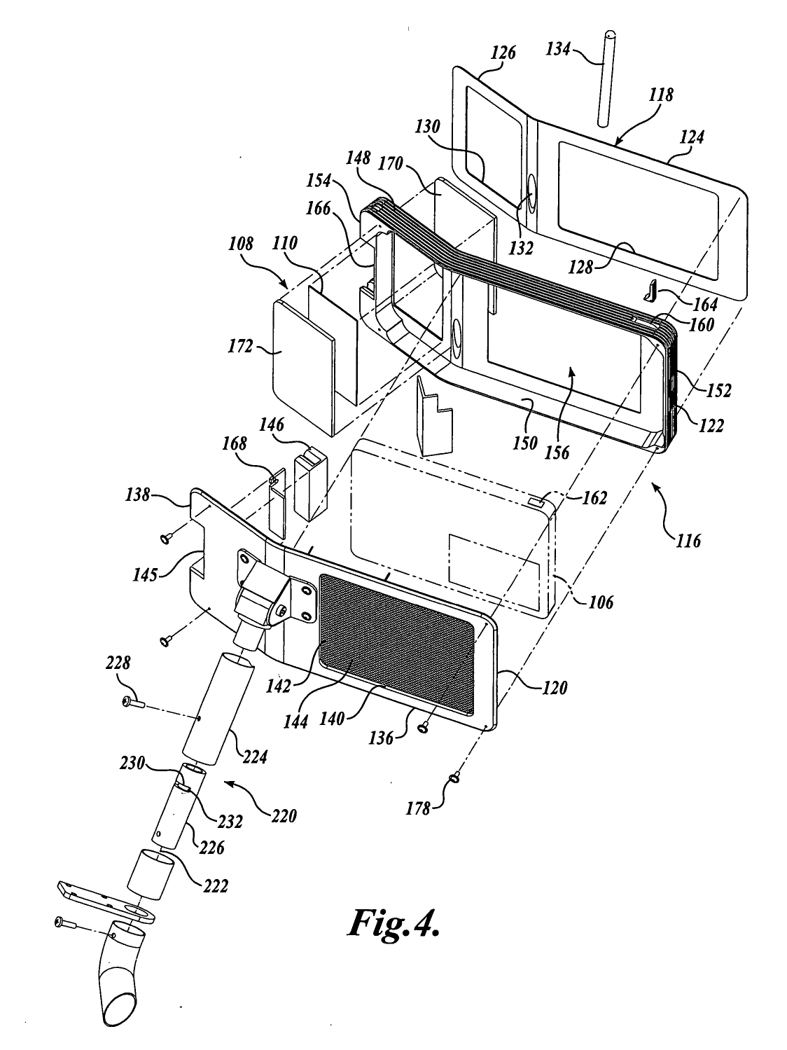

Turning to FIGS. 3 and 4, the peripheral frame 122 includes a top sidewall 148, a bottom sidewall 150, a left sidewall 152, and a right sidewall 154. The sidewalls 148, 150, 152, and 154 space the front panel 118 from the back panel 120, creating an interior volume 156 adapted to removably receive the graphics device 106. The sidewalls 148, 150, 152, and 154 may include vent apertures 158 to aid in permitting airflow exchange between the interior volume 156 and the surrounding environment, as seen in FIG. 3A. The vent opening or apertures 158 may be of any suitable form, such as elongate slots disposed substantially parallel to the length of the wall or walls 148, 150, 152, and 154 through which they extend. The elongate slots of FIG. 3A are shown disposed between adjacent raised elongate ribs 159 and oriented substantially parallel with the length of the top wall 148.

Still referring to FIG. 3A, the front panel 118 may be fastened to the frame 122 by securing the front panel 118 within a recess 119 disposed on the front side of the frame 122. The front panel 118 may be fastened to the frame 122 in any suitable manner, such as by mechanical fasteners, adhesives, by an interference fit, or snap-to-connect assembly, for instance. The back panel 120 may be fastened to the frame 122 by any suitable manner, such as by a plurality of fasteners 178 (see FIG. 4).

Still referring to FIGS. 3-4, the top wall 148 includes an access aperture 160 located in proximity to a power button 162 or switch of the graphics device 106 when the graphics device 106 is mounted in the interior volume. An access door 164 is associated with the access aperture 160. The access door 164 is selectively configurable between an access position (see FIG. 3) permitting user access to the interior volume 156 to toggle the power button 162 between on and off positions and a closed position impeding user access to the interior volume 156 and the power button 162.

The right sidewall 154 includes a recess 166 aligned with cutout 145 of the back panel for receiving the card reader 146. Preferably, the recess 166 is sized and dimensioned such that the card reader's 146 outer surfaces are mounted substantially flush with the outer surfaces of the housing 116 of the media display device 100. A card reader mounting bracket 168 may be used to facilitate the mounting of the card reader 146 to the media display device 100. The right sidewall 154 further includes an elongate slot 174 for permitting a data card 176 (such as a debit card, credit card, etc., having electronic readable data thereon) to be swiped through the slot 174.

The print media holder assembly 108 of the second graphics device preferably includes a front panel 170 of a substantially transparent material, one suitable example being a 1/16 inch-thick LEXAN® polycarbonate sheet. The front panel 170 may be secured by bending and then releasing the front panel 170 into the print media view opening 130. The print media holder assembly 108 further includes a back panel 172. The back panel 172 may include a pocket or recess for receiving print media 110 therein. The front panel 170 may be removed by bending and lifting the front panel 170 out of the print media view opening 130. The back panel 172 may then be readily accessed, for example, to change the print media 110 stored within the print media holder assembly 108.

Referring to FIG. 3, an attachment assembly 200 is coupled to the back panel 120. The attachment assembly 200 permits the media display device 100 to be movably suspended above the support structure 114 (see FIG. 1). The attachment assembly 200 includes a housing mounting bracket 202 coupled to the back panel 120 of the housing 116 for facilitating the mounting of the attachment assembly 200 to the housing 116. The attachment assembly 200 also includes a support structure mounting bracket 204 for facilitating the mounting of the attachment assembly 200 to the support structure. A support arm 206 extends between the two mounting brackets 202 and 204. The support arm 206 is preferably hollow to permit routing of at least one conductor wire 208 therein. The conductor wires 208 are preferably coupled in signal communication with the graphics device when stored within the media display device 100 and may be used to transfer power and/or electronic signals to and from the graphics device.

The attachment assembly 200 includes a pivot assembly 210 for permitting an inclination of the media display device 100 to be selectively inclined relative to the support structure. In the illustrated embodiment, the pivot assembly 210 is a gimballed joint having a pivot pin 212 passing through two opposing apertures in the housing mounting bracket 202 and through a hole in an upper end portion of the support arm 206. At least one limit stop 214 is disposed on the media display device mounting bracket 202 for limiting the angular displacement of the media display device 100 relative to the support structure through contact with the support arm 206.

In the illustrated embodiment, the pivot assembly 210 is a friction based system, wherein the pivot assembly 210 applies sufficient friction such that the media display device 100 is held in a selected angular orientation relative to the support surface once positioned by the user, but that does not apply too much friction such that a user cannot readily adjust the inclination of the media display device 100. In one embodiment, the user can adjust the media display device 100 through an angular displacement of about 180 degrees or less. In another embodiment, the media display device 100 is adjustable through an angular displacement of about 70 degrees, starting at an angular orientation of about 10 degrees from vertical and ending at an angular orientation of about 10 degrees below horizontal. Although specific angular orientations of the pivot assembly 210 are discussed above, it should be apparent to those skilled in the art that other angular orientations are suitable for use with and are within the spirit and scope of the present invention.

Refer now also to FIG. 4, wherein the attachment assembly 200 further includes a rotation assembly 220. The rotation assembly 220 permits the housing 116 to rotate about a central axis 222 of the support arm 206 a predetermined amount. The central axis 222 is preferably perpendicularly oriented relative to the horizontal axis about which the pivot assembly 210 rotates.

Focusing in more detail upon the rotation assembly 220, as seen in FIG. 4, the rotation assembly 220 includes an upper tube 224 that is rotatingly received over a smaller diameter base tube 226. A pin 228 projects inward from the upper tube 224. The base tube 226 includes a slot 230 disposed about a portion of the circumference of the base tube 226. The pin 228 is received in the slot 230 to impede vertical movement of the upper tube 224 relative to the base tube 226.

The pin 228 also slides along the length of the slot 230 to permit the upper tube 224 (and the housing 116) to rotate about the center axis 222 of the tubes 224 and 226 through a selected angular displacement relative to the base tube 226 (and the support structure). The length of the slot 230 determines the maximum extent of angular displacement the upper tube 224 may rotate relative to the base tube 226, each end of the slot 230 acting as an angular limit stop 232. In one embodiment, the angular displacement is limited by the slot 230 to less than about 180 degrees. In another embodiment, the angular displacement is limited by the slot 230 to less than about 135 degrees. In another embodiment, the angular displacement is limited by the slot 230 to less than about 90 degrees.

In light of the above description of the structure of the media display device 100, the operation of the media display device 100 will now be described. A graphics device 106 is placed within the interior volume 156 such that the screen 112 (FIG. 2) of the graphics device 106 is viewable through the digital media view opening 128. The card reader 146 is mounted in the card reader recess 166. Print media 110 is placed in the print media holder assembly 108 and the translucent front panel 170 snapped into place. The front panel 118 is then coupled to the back panel 120 with the frame 122 sandwiched therebetween. The attachment assembly 200 is then coupled to the housing 116 such that the housing 116 is movably coupled to the support structure, the housing 116 free to rotate about two axes of rotation oriented substantially perpendicularly to one another. The access door 164 is placed in an open position and the power button 162 of the graphics device 106 turned on.

Preferably, the graphics device 106 is coupled in signal communication with a power supply, server, and/or the internet. A user may use a data input device, a few suitable examples being the stylus 134, a mouse, touch, voice, etc., to input data into the graphics device 106. For instance, the graphics device 106 may be controlled by a user to communicate with a remote server to select musical selections for playback or recording upon a data recording device, such as a compact disk. The card reader 146 may be used to receive additional data from the user, one suitable example being a credit card account number to finance the use of the graphics device 106 or to provide payment in exchange for the right to download selected musical selections. The print media 110 displayed by the print media holder assembly 108 may be viewed by the user through the print media view opening 130, thereby relaying additional information to the user, such as products available, sales, information instructing the user on how to use the graphics device 106, etc.

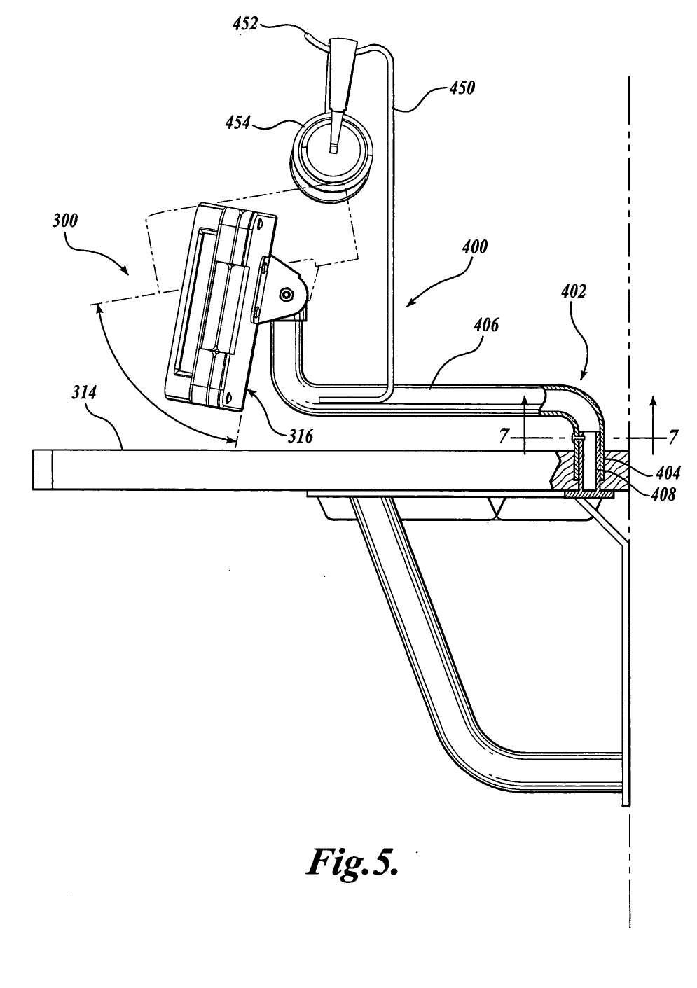

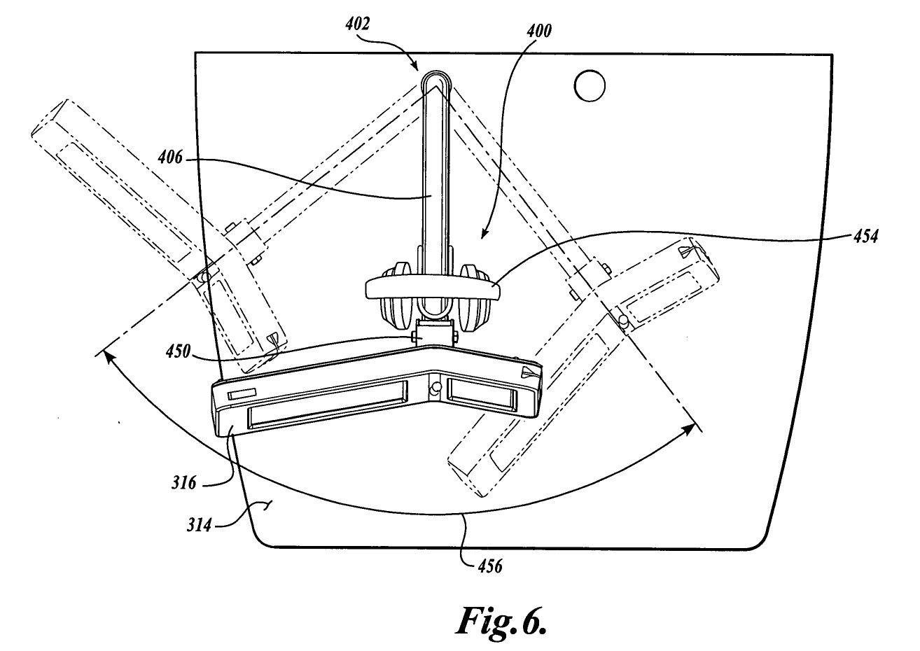

An alternate embodiment of a media display device 300 formed in accordance with the present invention is shown in FIGS. 5 and 6. The media display device 300 is substantially similar to the media display device depicted in and described in relation to FIGS. 1-4. Therefore, only those aspects of the media display device 300 of FIGS. 5 and 6 that depart from the first described embodiment will be described herein for the sake of brevity.

That said, the media display device 300 of FIGS. 5 and 6 departs from the above described media display device in that the attachment assembly 400 of the media display device 300 provides increased adjustability. Moreover, the attachment assembly 400 permits the media display device 300 housing 316 to be pivoted about a substantially horizontal axis through a selected angular displacement to adjust the inclination of the housing 316, identically as is done in the above embodiment, while also permitting the housing 316 to be rotated above the support structure 314 about a substantially vertical axis.

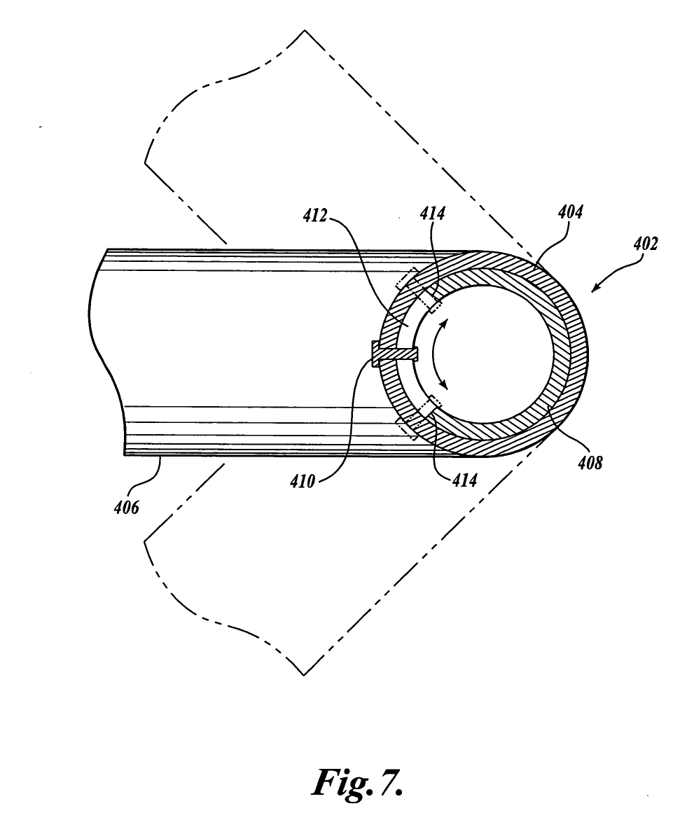

Moreover, the attachment assembly 400 includes the same pivot assembly as described above for permitting the inclination of the housing 316 to be adjusted. Additionally, the attachment assembly 400 includes a swing assembly 402 for permitting the housing 316 to swing through a predetermined arc 456 above the support structure 314. Referring to FIG. 7, the swing assembly 402 includes a support tube 406 having an elbow portion 404 that is rotatingly received over a smaller diameter base tube 408. A pin 410 is attached to the elbow portion 404 so as to project radially inward. The base tube 408 includes a slot 412 disposed about a portion of the circumference of the base tube 408. The pin 410 engages the top and bottom edges of the slot 412 to impede vertical movement of the elbow portion 404 relative to the base tube 408.

The pin 410 also slides along the length of the slot 412 to permit the support tube 406 to rotate about a substantially vertical axis through a selected angular displacement relative to the base tube 408. The length of the slot 412 determines the maximum extent of angular displacement the support tube 406 may rotate relative to the base tube 408, each end of the slot 412 acting as an angular limit stop 414. In one embodiment, the angular displacement is limited by the slot 412 to less than about 180 degrees. In another embodiment, the angular displacement is limited by the slot 412 to less than about 135 degrees. In another embodiment, the angular displacement is limited by the slot 412 to less than about 90 degrees.

Referring again to FIG. 5, the attachment assembly 400 further includes a hanger 450 extending upward from an intermediate, horizontal portion of the support arm 406. The hanger 450 includes a hook portion 452 for suspending an object, such as a pair of headphones 454, a predetermined distance above the support surface 314. The headphones 454 are preferably coupled in signal communication with the media display device 300 such that the media display device 300 may transmit audio signals to the user.

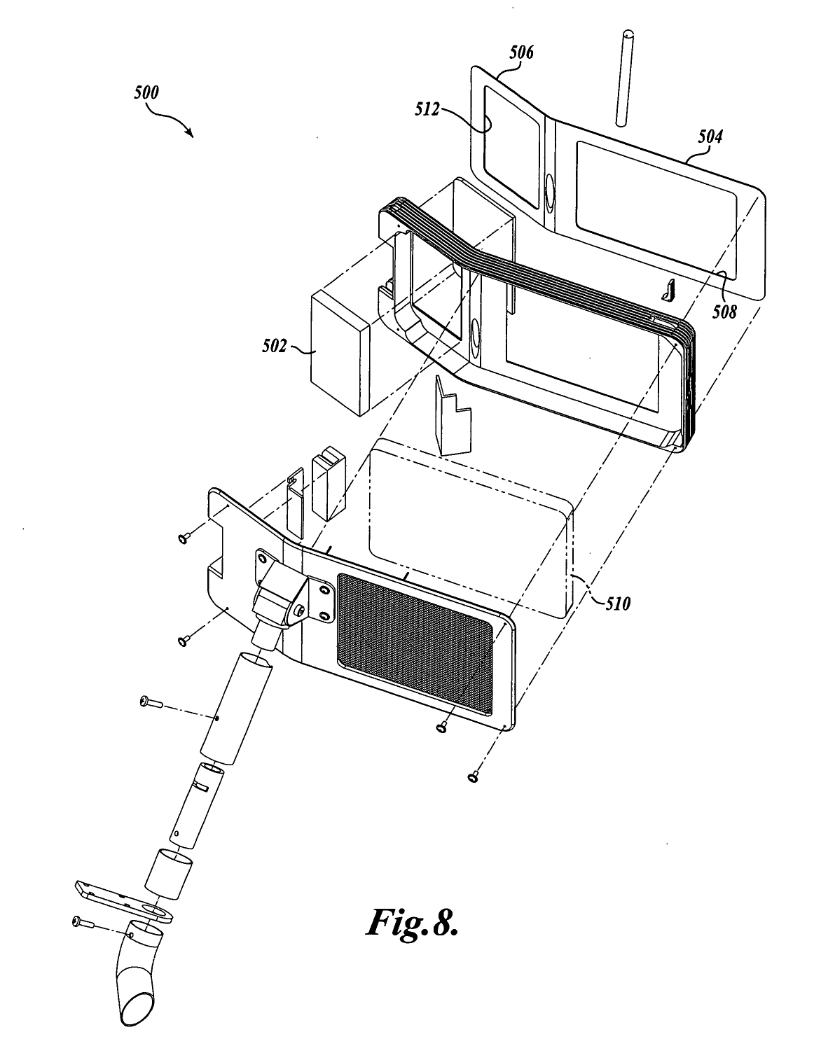

In the alternate embodiment of FIG. 8, a media display device 500 is substantially similar to the media display device depicted in and described with reference to FIGS. 1-4. Therefore, only those aspects of the media display device 500 of FIG. 8 that depart from the first described embodiment will be described herein for the sake of brevity.

That said, the media display device 500 of FIG. 8 departs from above described media display device in that the print media holder assembly has been removed and replaced with a second graphics device 502. Thus, the media display device 500 includes a first planar section 504 inclined to a second planar section 506. The first planar section 504 includes a first graphics view opening 508 that may be used to view electronic media displayed upon a screen of a first graphics device 510. The second planar section 506 includes a second graphics view opening 512 which may be used to view electronic media displayed upon a screen of a second graphics device 502, the second graphics device 502 being a tablet personal computer, such as a Personal Digital Assistant (PDA).

Although different embodiments are described above as having specific combinations of pivot assemblies, rotation assemblies, and/or swing assemblies, it should be apparent to those skilled in the art that embodiments in accordance with the present invention may have none, any one, or a combination thereof of these adjustment assemblies. Thus, embodiments wherein the housing is adjustable through rotations or orbits about one, two, or three or more different axes is within the spirit and scope of the present invention. Likewise, embodiments wherein the housing is non-movably (rigidly) coupled to a support structure are also within the spirit and scope of the present invention.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A media display device comprising:
(a) a housing at least partially defining an interior volume adapted to removably receive a tablet personal computer;
(b) a view opening disposed in the housing for permitting a user to view a graphics screen of the tablet personal computer when the tablet personal computer is received by the interior volume; and
(c) a print media holder assembly coupled to the housing for removably holding print media for viewing by the user.

2. The media display device of claim 1, wherein the housing includes:
(a) a first planar section; and
(b) a second planar section coupled to the first planar section, wherein the first planar section is inclined relative to the second planar section.

3. The media display device of claim 2, wherein the view opening is disposed on the first planar section and the print media holder assembly is located on the second planar section.

4. The media display device of claim 3, wherein the first planar section is inclined relative to the second planar section at an angle of about 10 degrees to about 50 degrees.

5. The media display device of claim 1, wherein the housing further includes a front panel, a back panel, and a plurality of side panels interposed therebetween and wherein the housing further includes a plurality of elongated vent openings disposed along at least a portion of one of the plurality of side panels for permitting airflow into or out of the housing.

6. The media display device of claim 1, wherein the housing further includes a recess adapted to receive a card reader.

7. The media display device of claim 1, wherein the housing further includes an elongate slot for permitting a card containing readable data to be swiped therethrough.

8. The media display device of claim 1, further including an access aperture disposed in the housing, the access aperture being selectively configurable between an access position permitting user access to the interior volume and a closed position impeding user access to the interior volume, wherein the access aperture is located in proximity to a power button of the tablet personal computer when the tablet personal computer is held by the media display device.

9. The media display device of claim 1, further including a mounting assembly coupled to the housing, the mounting assembly being adapted to couple to a support surface for adjustably suspending the media display assembly a predetermined distance above the support surface.

10. The media display device of claim 9, wherein the mounting assembly includes a pivot assembly for permitting the housing to be selectively pivoted to permit an inclination of the housing to be adjusted relative to the support surface.

11. The media display device of claim 10, wherein the mounting assembly includes a swing assembly for permitting the housing to be selectively rotated about a swing axis to allow the housing to be reciprocated along a predetermined path above the support surface.

12. The media display device of claim 9, wherein the mounting assembly further includes a hanger extending outward from the mounting assembly for suspending a pair of headphones above the support surface.

13. A media display device comprising:
(a) a housing at least partially defining an interior volume adapted to removably receive a screen for viewing digital images; and
(b) a media holder coupled to the housing for removably holding print media.

14. The media display device of claim 13, wherein the housing includes:
(a) a first planar section adapted to receive the screen; and
(b) a second planar section coupled to the first planar section, the second planar section including the media holder, wherein the first planar section is inclined relative to the second planar section.

15. The media display device of claim 14, wherein the first planar section is inclined relative to the second planar section at an angle about 10 degrees to about 50 degrees.

16. The media display device of claim 13, wherein the housing further includes an elongate slot for permitting a card containing readable data to be swiped therethrough.

17. The media display device of claim 13, further including an access aperture disposed in the housing, the access aperture selectively configurable between an access position permitting user access to the interior volume and a closed position impeding user access to the interior volume, wherein the access aperture is located in proximity to a power button associated with the screen when the screen is held by the media display device.

18. The media display device of claim 13, wherein the interior volume is sized and configured to at least partially receive a tablet personal computer having the screen.

19. The media display device of claim 13, further including a mounting assembly coupled to the housing, the mounting assembly adapted to couple to a support surface for adjustably suspending the media display assembly a predetermined distance above the support surface.

20. The media display device of claim 19, wherein the mounting assembly includes a pivot assembly for permitting the housing to be selectively pivoted to permit an inclination of the housing to be adjusted relative to the support surface.

21. The media display device of claim 20, wherein the mounting assembly includes a swing assembly for permitting the housing to be selectively rotated about a swing axis to allow the housing to be reciprocated along a predetermined path above the support surface.

22. The media display device of claim 19, wherein the mounting assembly further includes a hanger extending outward from the mounting assembly for suspending a pair of headphones above the support surface.

23. A media display device comprising:
(a) a housing having a first section inclined relative to a second section;
(b) a first graphics device coupled to the first section, the first graphics device including a tablet personal computer for displaying media images for user viewing; and
(c) a second graphics device coupled to the second section, the second graphics device adapted to display media images for user viewing.

24. The media display device of claim 23, further including a card reader coupled to the housing.

25. The media display device of claim 23, wherein the first section is inclined greater than about 10 degrees from the second section.

26. The media display device of claim 23, wherein the second graphics device includes a holder for holding print media.

27. The media display device of claim 23, wherein the second graphics device is a tablet personal computer.

28. The media display device of claim 23, further including a mounting assembly coupled to the housing, the mounting assembly adapted to couple to a support surface for adjustably suspending the media display assembly a predetermined distance above the support surface.

29. The media display device of claim 28, wherein the mounting assembly includes a pivot assembly for permitting the housing to be selectively pivoted to permit an inclination of the housing to be adjusted relative to the support surface.

30. The media display device of claim 29, wherein the mounting assembly includes a swing assembly for permitting the housing to be selectively rotated about a swing axis to allow the housing to be reciprocated along a predetermined path above the support surface.

31. The media display device of claim 28, wherein the mounting assembly further includes a hanger extending outward from the mounting assembly for suspending a pair of headphones above the support surface.
